(19) United States
(12) Patent Application Publication
(10) Pub. No.: US 2007/0010401 A1
(43) Pub. Date: Jan. 11, 2007

(54) Synergistic combination of a glyphosate herbicide and a triazole fungicide

(75) Inventors: Robert Andrew Noon, Surrey (GB); Harald Bernhard Teicher, Thyboroen (DK)

Correspondence Address: PILLSBURY WINTHROP SHAW PITTMAN, LLP, P.O. BOX 10500, MCLEAN, VA, 22102, US

(73) Assignee: Cheminova A/S, Lemvig (DK)

(21) Appl. No.: 11/471,579

(22) Filed: Jun. 21, 2006

Related U.S. Application Data
(60) Provisional application No. 60/692,249, filed on Jun. 21, 2005.
(60) Provisional application No. 60/795,647, filed on Apr. 28, 2006.

(51) Int. Cl. A01N 57/00; A01N 43/50

(52) U.S. Cl. 504/165; 514/397

(57) ABSTRACT

This invention relates to a synergistic combination of a triazole fungicide and glyphosate herbicide, or derivatives thereof, as well as methods of using the synergistic combination to control fungal disease in a glyphosate-resistant plant.

### PRIORITY CLAIM

This application claims priority to U.S. Provisional Application No. 60/692,249, filed Jun. 21, 2005, and U.S. Provisional Application No. 60/795,647, filed Apr. 28, 2006, both of which are herein incorporated by reference in their entirety.

### FIELD OF THE INVENTION

The present invention relates to a synergistic combination of a glyphosate herbicide or derivative thereof and a triazole fungicide. The synergistic combination may be used to protect glyphosate-resistant plants from harmful fungi.

### BACKGROUND

Herbicides inhibiting 5-enol pyruvylshikimate-3-phosphonate synthase (EPSPS) are well known as highly effective foliar herbicides. Of this class of herbicides, the most well known is N-(phosphonomethyl)glycine, also known as glyphosate. Glyphosate, while quite effective as a herbicide, lacks selectivity when applied to plant species, meaning that the glyphosate, when applied to an unmodified plant, often destroys the plant as much as it destroys or inhibits the unwanted vegetation. Therefore, the herbicide has been used under conditions where there is no need for selectivity (e.g. as a total herbicide) or under conditions where there is no growing crop foliage present (e.g. burn-down/no-till).

The unselective nature of glyphosate has led to the creation of plants that are tolerant to glyphosate herbicides, either through genetic modification or by introducing a tolerance trait into the plants through conventional breeding techniques. Plants tolerant to glyphosate and other herbicides may now be treated with glyphosate without incurring many of the limitations discussed above. For example U.S. Pat. Nos. 4,535,060; 4,769,061; 5,312,910; 5,633,435; 5,627,061; 6,066,786 and 4,940,835, all of which are herein incorporated by reference in their entirety, each relate to the modification of crops to confer tolerance to EPSPS-inhibiting (e.g. glyphosate) herbicides. Glyphosate-resistant plants have been used by farmers around the world on a commercial scale to grow various genetically modified crops, such as cotton, corn, canola, sugar beat, wheat, and soybean.

Methods of applying a glyphosate herbicide in glyphosate-resistant crops have also been disclosed as controlling fungal pathogens. See PCT publication no. WO 2005/041669, herein incorporated by reference in its entirety. According to the disclosed field report, glyphosate suppresses certain fungal pathogens, which leads to an increase in crop yield. However, glyphosate alone does not provide adequate control of such fungal pathogens.

An adequate control of fungal diseases involves the application of additional fungicidally active compounds. One example of fungicidally active compounds are triazole fungicides.

Triazole fungicides are economically important agricultural chemicals because of their protective, curative, and eradicant properties, as well as their ability to inhibit fungal ergosterol biosynthesis. As such, they are widely used on crops such as wheat, barley, soybean, and orchard fruits. Examples of triazole fungicides include those disclosed in “The Pesticide Manual” produced by The British Crop Protection Council (BCPC), herein incorporated by reference in its entirety.

Thus, what is needed is a method of protecting a plant against fungal diseases that utilizes the herbicidal and fungicidal activity of glyphosate while, at the same time, utilizes the fungicidal activity of triazole fungicides. This invention answers that need.

### SUMMARY OF THE INVENTION

The combination of a glyphosate herbicide or derivative thereof and a triazole fungicide is particularly effective in combating or preventing fungal diseases of glyphosate-resistant plants. The synergy between the herbicide and the fungicide is both surprising and unexpected.

In one embodiment, the invention relates to a method for controlling a plant fungal disease. The method comprises exposing a glyphosate-resistant plant to an effective amount of a synergistic combination of (a) a glyphosate herbicide or derivative thereof, and (b) a triazole fungicide.

In another embodiment, the invention relates to a method of treating a glyphosate-resistant plant. The method comprises the step of applying to the plant an effective amount of a synergistic combination of (a) a glyphosate herbicide or derivative thereof, and (b) a triazole fungicide.

In another embodiment, the invention relates to a fungicidal composition containing a synergistic fungicidally effective amount of (a) a glyphosate herbicide or derivative thereof, and (b) a triazole fungicide. The weight ratio of components (a):(b) range from about 50:1 to about 1:10.

In another embodiment, the invention relates to a fungicidal composition comprising two active components: (a) a first active component, a glyphosate herbicide or derivative thereof, and, (b) a second active component, a triazole fungicide. The first and second active components are present in a synergistically effective amount.

### DETAILED DESCRIPTION

The use of a glyphosate herbicide or derivative thereof, in combination with a triazole fungicide, surprisingly and synergistically enhances the fungicidal activity of the active components against fungi. Accordingly, this invention relates to a method for controlling a plant fungal disease comprising exposing a glyphosate-resistant plant to an effective amount of a synergistic combination of (a) a glyphosate herbicide or derivative thereof, and (b) a triazole fungicide. The invention also relates to a method of treating a glyphosate-resistant plant, where the method comprises the step of applying to the plant an effective amount of a synergistic combination of (a) a glyphosate herbicide or derivative thereof, and (b) a triazole fungicide. The methods are effective against a wide spectrum of fungal pathogens.

Many different plant and plant varieties have been developed that are tolerant to glyphosate herbicides. Most of these developments have been made by genetically modifying the plants or introducing tolerance traits into the plants through conventional breeding techniques. Any plant that has been genetically engineered or otherwise modified to have resistance to glyphosate falls within the definition of a glyphosate-resistant plant. Examples of glyphosate-resistant plants that can be protected from fungal diseases include glyphosate-resistant soybean, wheat, canola, corn, cotton, sugar beet, and turf grasses. The methods of the present invention are particularly suitable for protecting and treating soybean plants.

The methods may be used to control a wide range of fungal diseases including, but not limited to, powdery mildews, rusts, Septoria/Leptosphaeria leaf spots, Colletotrichum leaf spots, Cercospora leaf spots, Phoma leaf spots, and Fusarium blight. The methods are particularly suitable for use against rust diseases in various glyphosate-resistant crops, such as glyphosate resistant soybean plants. Most preferably, the methods are used to protect and treat soybean plants that are infected or could become infected with soybean rust caused by the fungi Phakopsora pachyrhizi and Phakopsora meibomiae (also referred to as Asian rust).

The glyphosate herbicide may be applied in its acid form or as a derivative thereof, such as an ammonium salt (e.g. isopropylammonium, monoethanolammonium or ammonium), an alkali metal salt (e.g. sodium or potassium), a trimesium salt or mixtures thereof. Other known glyphosate derivatives may also be used.

Examples of suitable triazole fungicides include cyproconazole, epoxiconazole, fenbuconazole, fluquinconazole, flutriafol, hexaconazole, propiconazole, prothioconazole, tetraconazole, triticonazole, tebuconazole, etaconazole, penconazole, diclobutrazole, flusilazole, diniconazole, triadimefon, triadimenol, bitertanol, and myclobutanil. Each of these fungicides is commercially available. A particularly preferred fungicide is flutriafol.

The weight ratio of the glyphosate herbicide (a) to the triazole fungicide (b) is selected to provide a synergistic fungicidal action. In general, the weight ratio of (a):(b) ranges from about 50:1 to about 1:10. The weight ratio of (a):(b) will depend on various factors which include but are not limited to the particular active components, the mode of application, the pathogenic fungi to be combated, the glyphosate-resistant plant, and the application time.

An effective amount of glyphosate herbicide and triazole fungicide is any amount that has the ability to fungicidally protect or treat the plant. Effective aggregate amounts of the glyphosate herbicide and triazole fungicide range from about 10 to about 4000 g/ha. In general, satisfactory synergistic fungicidal results will be obtained when employing from about 10 to about 3000 g/ha of glyphosate herbicide, preferably from about 100 to about 1000 g/ha of glyphosate herbicide; and from about 3 to about 1000 g/ha of the triazole fungicide, preferably from about 10 to about 300 g/ha of the triazole fungicide.

The plants may be controlled by applying treatments prior to, during, and/or after a fungal attack, i.e. as a prophylactic application, as a therapeutic application, or both. The plants may be controlled at any growth stage and at multiple growth stages. For example, a treatment may be applied at any early growth stage, such as V1 or V2, at later growth stages, such as R1 to R3, and/or at any subsequent time that fungi has developed on the plant. As used herein, “controlling” the plant fungi encompasses protecting the plant, treating the plant, or otherwise administering a treatment to the plant at any time during the growth stage of a plant, both before and after infection of a fungal disease.

Compositions containing the glyphosate herbicide and triazole fungicide may be employed in any conventional form, for example, in the form of a twin pack, or as an emulsifiable concentrate, soluble concentrate, suspension concentrate, microemulsion, wettable powder, ready-to-spray solution, soluble granule, or water-dispersible granule. Such compositions can be formulated using adjuvants and formulation techniques that are known in the art for individually formulating either the herbicide or the fungicide. For example, the glyphosate herbicide or derivative thereof and the triazole fungicide may be mixed together, optionally with other formulating ingredients.

The compositions may contain a diluent, which may be added during the formulation process, after the formulation process (e.g. by the user—a farmer or custom applicator), or both. The term diluent includes all liquid and solid agriculturally acceptable material-including carriers which may be added to the herbicide and/or fungicide to bring them in a suitable application or commercial form. Examples of suitable solid diluents or carriers are aluminium silicate, talc, calcined magnesia, kieselguhr, tricalcium phosphate, powdered cork, absorbent carbon black, chalk, silica, and clays such as kaolin and bentonite. Examples of suitable liquid diluents include water, organic solvents (e.g. acetophenone, cyclohexanone, isophorone, toluene, xylene, petroleum distillates), amines (e.g. ethanolamine, dimethylformamide), and mineral, animal, and vegetable oils (used alone or in combination).

Additional fungicides may be also be used provided that the additional fungicide does not interfere with the synergistic relationship between the primary triazole fungicide and the glyphosate herbicide. An additional fungicide may be utilized if broadening of the spectrum of disease control or preventing the build-up of resistance is desired. For instance, it may be advantageous in the agricultural practice to combine two or three fungicides with the glyphosate herbicide or derivative thereof.

Suitable additional fungicides include 2-aminobutane; 8-hydroxyquinoline sulphate; 2-phenylphenol (OPP), aldi-morph, ampropylfos, anilazine, azoxystrobin, benalaxyl, benodanil, benomyl, binapacryl, biphenyl, blasticidin-S, bupirimate, buthiobate, calcium polysulphide, captafol, captan, carbendazim, carboxin, carpropamid, quinomethionate, chloroneb, chloropicrin, chlorothalonil, chlozolinate, cufraneb, cyazofamid, cymoxanil, cyprodinil, cyprofuram, dichlorophen, diclocymet, diclofluanid, diclomezin, dicloran, diethofencarb, diflumetorim, dimethirimol, dimethomorph, dinocap, diphenylamine, dipyrithion, ditalimfos, dithianon, dodine, drazoxolon, edifenphos, enestroburin, ethaboxam, ethirimol, etridiazole, famoxadone, fenamidone, fenarimol, fenfuram, fenhexamid, fenitropan, fenpiclonil, fenpropidin, fenpropimorph, fentin acetate, fentin hydroxide, ferbam, ferimzone, fluazinam, fludioxonil, flumorph, fluoromide, fluoxastrobin, flusulfamide, flutolanil, folpet, fosetyl-aluminium, fthalide, fuberidazole, furalaxyl, furmecyclox, guazatine, hexachlorobenzene. imazalil, iminoctadine, iprobenfos (IBP), iprodione, iprovalicarb, isoprothiolane, kasugamycin, copper preparations such as: copper hydroxide, copper naphthenate, copper oxychloride, copper sulphate, copper oxide, oxine-copper and Bordeaux mixture, mancopper, mancozeb, maneb, mepanipyrim, kresoxim-methyl, mepronil, metalaxyl, methasulfocarb, methfuroxam, metiram, metominostrobin, metrafenone, metsulfovax, myclobutanil, nickel dimethyldithiocarbamate, nitrothal-isopropyl, nuarimol, ofurace, oxadixyl, oxamocarb, oxycarboxin, pefurazoate, pencyuron, phosdiphen, picoxystrobin, pimaricin, piperalin, polyoxin, probenazole, prochloraz, procymidone, propamocarb, propineb, pyraclostrobin, pyrazophos, pyrifenox, pyrimethanil, pyroquilon, quinoxyfen, quintozene (PCNB), silthiofam, spiroxamine, sulphur and sulphur preparations, tecloftalam, tecnazene, thiabendazole, thicyofen, thifluzamide, thiophanate-methyl, thiram, tolclophos-methyl, tolylfluanid, triazoxide, trichlamide, tricyclazole, tridemorph, trifloxystrobin, triflumizole, triforine, validamycin, vinclozolin, zineb, ziram, zoxamide, and combinations thereof.

The compositions containing the glyphosate herbicide and triazole fungicide may also contain any one or combination of the following: surfactants, protective colloids, thickeners, penetrating agents, stabilizers, sequestering agents, anti-caking agents, coloring agents, corrosion inhibitors, and dispersants such as lignosulfite waste liquors and methylcellulose. The term surfactant, as used herein, means an agriculturally acceptable material which imparts emulsifiability, stability, spreading, wetting, dispersibility or other surface-modifying properties. Examples of suitable surfactants include lignin sulfonates, fatty acid sulfonates (e.g. lauryl sulfonate), the condensation product of formaldehyde with naphthalene sulfonate, alkylarylsulfonates, ethoxylated alkylphenols, and ethoxylated fatty alcohols. Other known surfactants that have been used with herbicides or fungicides may are also acceptable.

When mixed with additional components, the composition typically contains about 0.01 to about 90% by weight of herbicides and fungicides, about 0 to about 20% agriculturally acceptable surfactants, and about 10 to 99.99% solid or liquid diluent. The compositions may additionally contain other additives known in the art, such as pigments, thickeners and the like.

The glyphosate herbicide and triazole fungicide composition may be applied in various combinations of the two components. For example, they may be applied as a single “ready-mix” form, or in a combined spray mixture composed from separate formulations of the components, e.g. a “tank-mix” form. The components may also be applied separately and/or sequentially, provided that the application of the second component occurs within a reasonable period of time (within a few hours or days) from the application of the first component. The order of applying the individual components (a) and (b) is not essential. Rates of application of the composition will vary according to prevailing conditions such as the fungicides utilized, targeted fungi, degree of infestation, weather conditions, soil conditions, crop species, mode of application, and application time.

Compositions containing the glyphosate herbicide and triazole fungicide may be applied in the manner which they are formulated, as discussed above. For example, they may be applied as sprays, such as water-dispersible concentrates, wettable powders, or water-dispersible granules. The glyphosate herbicide is preferably applied as a spray, as the effectiveness of the herbicide significantly diminishes upon contact with the soil. The fungicide, on the other hand, may be applied through any of the above-described means. If the fungicide and herbicide are applied in a single formulation, then that formulation is preferably applied through spraying.

A synergistic effect exists whenever the action of a combination of active components is greater than the sum of the action of each of the components alone. Therefore, a synergistic combination is a combination of active components having an action that is greater than the sum of the action of each active component alone, and a synergistically effective amount is an effective amount of a synergistic combination. Well-known methods for determining whether synergy exists include the Colby method, the Wadley method, and the Tammes method, all of which are described below. Any one of these methods may be used to determine if synergy exists between the glyphosate herbicide and the triazole fungicide.

In the Colby method, also referred to as the Limpels method, the action to be expected (E) for a given active ingredient combination obeys the so-called Colby formula. According to Colby, the expected (additive) action of active ingredients I+II using p+q ppm of active ingredient is:

$$E = X + Y - \frac{X \cdot Y}{100}$$

where ppm equals the milligrams of active ingredient (=a.i.) per liter of spray mixture; X equals the % action by component (a) using p ppm of active ingredient; Y equals the % action by component (b) using q ppm of active ingredient. If the action actually observed (O) is greater than the expected action (E), then the action of the combination is superadditive, i.e. there is a synergistic effect. For a more detailed description of the Colby formula, see Colby, S. R. “Calculating synergistic and antagonistic responses of herbicide combination,” Weeds, Vol. 15, pages 20-22; (1967); see also Limpel et al., Proc. NEWCC 16: 48-53 (1962), both of which are herein incorporated by reference in their entirety.

In the Wadley method, the synergistic action is determined from the dose response curves. With this method, the efficacy of the active ingredient (a.i.) is determined by comparing the degree of fungal attack on treated plants with that on untreated, similarly inoculated and incubated check plants. Each active ingredient is tested at 4 to 5 concentrations. The dose response curves are used to establish the EC90 (i.e. the concentration of a.i. providing 90% disease control) of the individual compounds as well as of the combinations (EC90_{observed}). The experimentally determined values of the alone mixtures at a given weight ratio are compared with the values that would have been found if only a complementary efficacy of the components was present (EC90(A+B)_{observed}). The (EC90(A+B)_{expected}) is calculated by Wadley as:

$$EC 90 {( A + B )}_{expected} = \frac{a + b}{\frac{a}{EC 90 {( A )}_{observed}} + \frac{b}{EC 90 {( B )}_{observed}}}$$

wherein a and b are the weight ratios of the compounds A and B in the mixture and the indexes (A), (B), (A+B) refer to the observed EC90 values of the individual compounds A and B and the given combination A+B, respectively. The ratio EC90(A+B)_{expected}/EC90(A+B)_{observed} expresses the factor of interaction (F). If F is >1 then the action of the combination A+B is synergistic. For a more detailed description of the Wadley method, see Levi et al., EPPO-Bulletin 16: 651-657 (1986), which is herein incorporated by reference in its entirety.

The Tammes method uses a graphic representation to determine whether a synergistic effect exists. See “Isoboles, a graphic representation of synergism in pesticides,” Netherlands Journal of Plant Pathology, 70: 73-80 (1964), which is herein incorporated by reference in its entirety.

The foregoing disclosure of the preferred embodiments of the invention has been presented for purposes of illustration and description. It is not intended to be exhaustive or to limit the invention to the precise embodiments disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the invention should not be limited to the performance of their steps in the order written, and one skilled in the art can readily appreciate that the sequences may be varied and still remain within the spirit and scope of the invention.

### EXAMPLE 1

Protective Treatment. Three days prior to inoculation with Phakopsora pachyrhizi, glyphosate resistant soybean plants are treated with one of the following: (a) a combination of flutriafol (Impact—125 g/l flutriafol suspension concentrate (SC) formulation) and a glyphosate (Glyfos—isopropylammonium glyphosate formulation, 360 g/l based on glyphosate acid equivalent); (b) the flutriafol alone; or (c) the glyphosate alone. The combined treatment was a combined mixture composed from separate glyphosate and flutriafol formulations in a “tank-mix” form. Inoculation with the soybean rust urediospores is done on the adaxial and abaxial surface of the third trifoliate leaf (V3-R1). The inoculated plants are placed in darkness/high humidity at 21° C. for 16 h and subsequently transferred to a 17-27° C. regime, high humidity. Treatments are done in triplicate. Four weeks after inoculation, disease incidence and severity is determined on the first trifoliate. The Colby method is used to determine synergy.

TABLE 1
Synergistic protection of soybean plants from Phakopsora pachyrhizi
using a combined flutriafol and glyphosate treatment

| | | | | Synergism | Synergism- |
|---|---|---|---|---|---|
| Active substance | | Observed | Expected | ratio | related |
| (AI) | g AI/hectare | control (O) % | control (E) % | (R = O/E) | increase % |
| Glyphosate (acid) | 100 | 82 | | | |
| Flutriafol | 30 | 11 | | | |
| Glyphosate + Flutriafol | 100 + 30 | 90 | 84 | 1.1 | 7.1 |

### EXAMPLE 2

Curative treatment. Three days after glyphosate resistant soybean plants are inoculated with Phakopsora pachyrhizi, the plants are treated with one of the following: (a) a combination of flutriafol (Impact—125 g/l flutriafol suspension concentrate (SC) formulation) and a glyphosate (Glyfos—isopropylammonium glyphosate formulation, 360 g/l based on glyphosate acid equivalent); (b) the flutriafol alone; or (c) the glyphosate alone. The combined treatment was a combined mixture composed from separate glyphosate and flutriafol formulations in a “tank-mix” form. Inoculation with the soybean rust urediospores is done on the adaxial and abaxial surface of the third trifoliate leaf (V3-R1). The inoculated plants are placed in darkness/high humidity at 21° C. for 16 h and subsequently transferred to a 17-27° C. regime, high humidity. The treatments are done in triplicate. Four weeks after inoculation, disease incidence and severity is determined on the first trifoliate. The Colby method is used to determine synergy.

TABLE 2
Synergistic control of Phakopsora pachyrhizi infection in soybean plants using a
combined flutriafol and glyphosate treatment

| | | | | Synergism | Synergism- |
|---|---|---|---|---|---|
| Active substance | | Observed | Expected | ratio | related |
| (AI) | g AI/hectare | control (O) % | control (E) % | (R = O/E) | increase % |
| Glyphosate (acid) | 100 | 27 | | | |
| Flutriafol | 30 | 39 | | | |
| Glyphosate + Flutriafol | 100 + 30 | 85 | 56 | 1.5 | 51.8 |

The examples demonstrate the synergism of applying a glyphosate herbicide (glyphosate) and a triazole fungicide (flutriafol) to a glyphosate-resistant plant to control a plant fungal disease (Phakopsora pachyrhizi). Synergism is shown both as a protectant treatment (before the plant has been exposed to the soybean rust, as in Example 1) and as a curative treatment (after the plant has been exposed to soybean rust, as in Example 2).

What is claimed is:

1. A method for controlling a plant fungal disease comprising exposing a glyphosate-resistant plant to an effective amount of a synergistic combination of (a) a glyphosate herbicide or derivative thereof, and (b) a triazole fungicide.

2. The method according to claim 1, wherein the triazole fungicide is selected from the group consisting of cyproconazole, epoxiconazole, fenbuconazole, fluquinconazole, flutriafol, hexaconazole, propiconazole, prothioconazole, tetraconazole, triticonazole, tebuconazole, etaconazole, penconazole, diclobutrazole, flusilazole, diniconazole, triadimefon, triadimenol, bitertanol, myclobutanil and mixtures thereof.

3. The method according to claim 2, wherein the triazole fungicide is flutriafol.

4. The method according to claim 1, wherein the plant is soybean, wheat, canola, corn, cotton, sugar beat, or turf grass.

5. The method according to claim 4, wherein the plant is soybean.

6. The method according to claim 1, wherein the fungal disease is a rust disease.

7. The method according to claim 6, wherein the rust disease is caused by Phakopsora pachyrhizi or Phakopsora meibomiae.

8. The method according to claim 1, wherein the glyphosate derivative is a salt selected from the group consisting of the mono isopropylammonium salt of glyphosate, the sodium salt of glyphosate, the potassium salt of glyphosate, the trimesium salt of glyphosate, the monoethanolammonium salt of glyphosate, the ammonium salt of glyphosate and mixtures thereof.

9. The method according to claim 1, wherein the method is being applied as a prophylactic treatment.

10. The method according to claim 1, wherein the method is being applied as a therapeutic treatment.

11. A method of treating a glyphosate-resistant plant, comprising applying to the plant an effective amount of a synergistic combination of (a) a glyphosate herbicide or derivative thereof, and (b) a triazole fungicide.

12. The method according to claim 11, wherein the triazole fungicide is selected from the group consisting of cyproconazole, epoxiconazole, fenbuconazole, fluquinconazole, flutriafol, hexaconazole, propiconazole, prothioconazole, tetraconazole, triticonazole, tebuconazole, etaconazole, penconazole, diclobutrazole, flusilazole, diniconazole, triadimefon, triadimenol, bitertanol, myclobutanil and mixtures thereof.

13. The method according to claim 12, wherein the triazole fungicide is flutriafol.

14. The method according to claim 11, wherein the plant is soybean, wheat, canola, corn, cotton sugar beat, or turf grass.

15. The method according to claim 14, wherein the plant is soybean.

16. The method according to claim 11, wherein the plant is infected or capable of becoming infected with a fungal disease.

17. The method according to claim 16, wherein the fungal disease is a rust disease.

18. The method according to claim 17, wherein the rust disease is caused by Phakopsora pachyrhizi or Phakopsora meibomiae.

19. The method according to claim 11, wherein the glyphosate derivative is a salt selected from the group consisting of the mono isopropylammonium salt, the sodium salt, the potassium salt, the trimesium salt, the monoethanolammonium salt of glyphosate, the ammonium salt of glyphosate and mixtures thereof.

20. The method according to claim 16, wherein the method is being applied as a prophylactic treatment and the plant has not been infected with a fungal disease.

21. The method according to claim 16, wherein the plant is infected with a fungal disease and the method is being applied as a therapeutic treatment.

22. A fungicidal composition comprising a synergistic fungicidally effective amount of (a) a glyphosate herbicide or derivative thereof, and (b) a triazole fungicide, wherein the weight ratio of components (a):(b) range from about 50:1 to about 1:10.

23. The composition according to claim 22, wherein the triazole fungicide is selected from the group consisting of cyproconazole, epoxiconazole, fenbuconazole, fluquinconazole, flutriafol, hexaconazole, propiconazole, prothioconazole, tetraconazole, triticonazole, tebuconazole, etaconazole, penconazole, diclobutrazole, flusilazole, diniconazole, triadimefon, triadimenol, bitertanol, myclobutanil and mixtures thereof.

24. The composition according to claim 23, wherein the triazole fungicide is flutriafol.

25. The composition according to claim 22, wherein the glyphosate derivative is a salt selected from the group consisting of the mono isopropylammonium salt, the sodium salt, the potassium salt, the trimesium salt, the monoethanolammonium salt of glyphosate, the ammonium salt of glyphosate and mixtures thereof.

26. A fungicidal composition comprising a first active component and a second active component, wherein the first active component (a) is a glyphosate herbicide or derivative thereof, and, wherein the second active component (b) is a triazole fungicide, and further wherein the first and second active components are present in synergistically effective amounts.

27. The composition of claim 26, wherein the weight ratio of components (a):(b) ranges from about 50:1 to about 1:10.

28. The composition according to claim 26, wherein the triazole fungicide is selected from the group consisting of cyproconazole, epoxiconazole, fenbuconazole, fluquinconazole, flutriafol, hexaconazole, propiconazole, prothioconazole, tetraconazole, triticonazole, tebuconazole, etaconazole, penconazole, diclobutrazole, flusilazole, diniconazole, triadimefon, triadimenol, bitertanol, myclobutanil and mixtures thereof.

29. The composition according to claim 28, wherein the triazole fungicide is flutriafol.

30. The composition according to claim 26, wherein the glyphosate derivative is a salt selected from the group consisting of the mono isopropylammonium salt, the sodium salt, the potassium salt, the trimesium salt, the monoethanolammonium salt of glyphosate, the ammonium salt of glyphosate and mixtures thereof.

31. A process for preparing a fungicidal composition comprising mixing a diluent and/or surfactant with a synergistically effective amount of a first active component and a second active component, wherein the first active component (a) is a glyphosate herbicide or derivative thereof, and, wherein the second active component (b) is a triazole fungicide, and further wherein the first and second active components are present in synergistically effective amounts.
